(19) United States
(12) Patent Application Publication
(10) Pub. No.: US 2011/0291006 A1
(43) Pub. Date: Dec. 1, 2011

(54) Application of a bistable energy system in overcomming uncertainty

(76) Inventor: James D. Welch, Omaha, NE (US)

(21) Appl. No.: 13/136,517

(22) Filed: Aug. 4, 2011

Related U.S. Application Data
(63) Continuation-in-part of application No. 13/066,755, filed on Apr. 25, 2011.
Application No. 13/066,755 is a continuation-in-part of application No. 12/806,521, filed on Aug. 16, 2010, now abandoned.
Application No. 12/806,521 is a continuation-in-part of application No. 12/387,450, filed on May 4, 2009, now abandoned.
(60) Provisional application No. 61/458,596, filed on Nov. 29, 2010.
(60) Provisional application No. 61/464,123, filed on Feb. 28, 2011.
(60) Provisional application No. 61/465,856, filed on Mar. 26, 2011.

(51) Int. Cl. H01J 47/00

(52) U.S. Cl. 250/305

(57) ABSTRACT

A proposed approach to determining both the Energy of an electron in an atom, and time of its existence is presented. The approach utilizes information about the physical system involved to overcome the limitation of the uncertainty principle.

This Application is a CIP of Ser. No. 13/066,755 Filed Apr. 25, 2011, and therrevia of Ser. No. 12/806,521 Filed Aug. 16, 2010; and of Pending application Ser. No. 12/387,450 Filed May 4, 2009, and therevia Claims Benefit of 61/211,514 Filed Mar. 31, 2009. This Application also directly Claims benefit of and of 61/458,596 Filed Nov. 29, 2010, 61/464,123 Filed Feb. 28, 2011 and of 61/465,856 Filed Mar. 26, 2011.

### TECHNICAL FIELD

The present invention relates to systems and method for investigating the validity of the Heisenberg Uncertainty Principle, and more specifically to an approach to arriving at, and the arrived at result involving a bistable energy system and how it suggests the Uncertainty Principle is avoided.

### BACKGROUND

Welch has previously described, in Parent application Ser. No. 13/066,755, a method of determining through which slit of a double slit system a particle passes, or at least is more likely to have passed, in formation of an interference pattern. Said method comprised the steps of:

a) providing a double slit system which comprises:
a′) a source of particles;
a″) a barrier having two slits therein;
a′″) a screen.
   In use a particle is caused by said source thereof to approach and pass through a slit in said barrier, then impinge on said screen; and such that when a multiplicity of particles are so caused to pass through one or the other slit in said barrier, then impinge on said screen, an interference pattern emerges, said interference pattern having positive and negative slopes on both sides of a center point of said interference pattern.

Said screen further has means for allowing lateral motion in response to momentum transfer from an impinging particle.

The method continues with:
b) causing said source to project a particle toward said barrier such that it passes through one of the slits and impinges said screen in a manner allowing the position at which is impinges to be identified, as well as how far said screen moves laterally in response to momentum being transferred thereto.
   Said method further comprises:
c) determining that for particles contributing to positive slope regions in the interrerence pattern to the right of said interference pattern central region and for particles contributing to negative slope regions in the interrerence pattern to the left of said interference pattern central region that the screen lateral motion is greater than for particles contributing to negative slope regions in the interrerence pattern to the right of said interference pattern central region and for particles contributing to positive slope regions in the interrerence pattern to the left of said interference pattern central region; and
concluding therefrom that on both sides of the central region of the interference pattern, particles contributing to positive slope regions predominantly pass through the left slit and that particles contributing to negative slope regions predominantly pass through the right slit, said tems right and left being as viewed from said source.

Another previous invention method comprises the steps of:

a) providing a double slit system which comprises:
a′) a source of particles;
a″) a barrier having two slits therein;
a′″) a screen.
   In use a particle is caused by said source thereof to approach and pass through a slit in said barrier, then impinge on said screen.

Said screen further has means for allowing motion perpendicular to a lateral locus of said screen in response to momentum transfer from an impinging particle.

Said method further comprises:
b) causing said source to project a particle toward said barrier such that it passes through one of the slits and impinges said screen in a manner allowing the position at which is impinges to be identified, as well as how far said screen moves perpendicular to a lateral locus of said screen in response to momentum being transferred thereto.
   Further, the method continues with:
c) determining how far the screen moves perpendicular to said lateral locus thereof in response to a particle impinging thereupon; and
concluding therefrom the location on said screen upon which the particle impinged, and its momentum from the motion thereof how far the screen moves perpendicular to said lateral locus thereof in response to a particle impinging thereupon.

Continuing, while the present invention is also focused on a new method to overcome the Uncertainty Principle, it is necessary to first set the stage as to how the invention was conceived. With that in mind, it is disclosed that in an article titled “Mind”, ISAST J. of Computers and Intelligent Systems, Vol. 3, No. 1, 2011, (11) Welch drew analogy between a proposed robotic control system and the human mind, wherein the robotic system is intended to survive in, explore, and to some extent control an environment. The robotic system was described as comprising sensory and motor capabilities and a plurality of sensors, (eg. to monitor temperature, radiation, chemical content of the atmosphere etc.), and motor means for effecting required motions.

In addition the robotic system comprised a battery power source, protective shielding which could be deployed when conditions require it, heating and cooling means, and a basic memory for receiving data from the plurality of sensors in parallel, over a sequential period of time. The robotic system also comprised a processor to monitor things such as low battery, and a basic raw data processor for monitoring acquired data. The basic raw data processor was described as having the capability of identifying, for instance, dangerous temperature and/or radiation levels indicated by data entered into the basic memory, and quickly automatically deploy heating or cooling or shielding etc. to prevent system damage. In addition, as the robotic system was intended to investigate and even control, to some extent, the environment being investigated, the robotic system would require an advanced data processor. While the advanced data processor could directly access the basic memory into which raw data is entered from sensory means, it was suggested that an engineer might realize that it could be advantageous to provide separate advanced memory into which is, from the basic memory, via circuitry, entered processed data which the advanced data processor can more easily access and utilize.

It was noted that such a robotic system, while lacking a life motivation source, might be considered to comprise somatic level capability for system monitoring and, for instance, providing an alert when battery voltage is low. Such a robotic system might also be considered to comprise a reactive stimulus response level capability which, upon detecting a perceived dangerous environmental condition, (eg. high temperature and/or radiation or adverse atmospheric chemical content etc.), automatically reacts to the perceived emergency and deploys protective means, while also, perhaps, suppressing control by the advanced data processor in order to avoid contradictory control which might be indicated thereby. Said robotic system might also be considered to comprise an analytic capability associated with the advanced memory and advanced data processor, which, when environmental conditions permit, analyzes data available to it and logically applies the results of that analysis to investigate, and to some extent control the environment in which it finds itself.

The described robotic system provided a functional approach to achieving a goal in an efficient manner. However, it was suggested that if the circuitry between the basic memory and the advanced memory fails, or only operates intermittently, serious malfunction in the environment investigation and control goal would occur as the advanced memory would not know what data was entered into the basic memory, and therefore would have limited insight as to what the environment was presenting. The basic memory and basic raw data processor, however, would remain fully operable and therefore would effect control which would be completely impossible for the advanced processor to interpret and in a robotic system sense, understand.

With the foregoing in mind, it was also disclosed that the author, in 1975-76 wrote and presented two papers (2,3) at the University of Nebraska Medical Center under Dr. Alvin Earle, in partial fulfillment of the requirements of two Advanced Neuro Anatomy Courses. The second paper combined Dianetic, theory with medical literature pertaining to memory, that had been presented in the first paper. The most important aspects of those papers are presented herein.

Continuing, Dianetics (1), teaches that the human mind is comprised of at least three distinguishable operational levels, (eg. somatic, reactive and analytical). The somatic level monitors and controls bodily functions usually below the level of consciousness, such as breathing and heartbeat. The reactive level is a stimulus response mechanism, much like that of animals. And, the analytical level is a rational mind which, for instance, perceives situations and data, analyzes what is perceived and postulates optimum courses of conduct and solutions to problems. The reactive mind is a tough mechanism that is always in the circuit, even though it is the level typically termed the subconscious mind. That is, somewhat confusingly, the subconscious mind is actually always conscious and it constantly records all perceptics available to it. On the other hand, the analytical mind, while being what is typically meant by terms such as the conscious human mind, is a delicate mechanism which nature has provided with something like a fuse that an engineer provides in an electronic circuit, to prevent it from being subjected to an overloading which can burn it out. That is, the analytical mind goes out of the circuit, (ie. unconscious), when an overwhelming situation occurs. The problem that develops is that in everyday life situations, it occurs that the analytical mind becomes attenuated, (ie to some extent unconscious), while the reactive mind is fully engaged, (ie. conscious but unbeknownst to the analytical mind). The reactive mind records everything a human perceives, but particularly during very emotional and/or painful experiences some of that can be unknown to the analytical mind, as it is not transferred from the reactive level to a conscious analytical mind. (Wolf (12)-(16) might describe this as the reactive mind pops qwiffs unbeknownst to the analytical mind). Further, a problem develops in that the reactive mind does not distinguish between one point in time and another and it interprets language literally. Continuing, if a human's reactive mind survived a painful experience ten years ago, and the perceptics of that experience are approximated in present time, the reactive mind will attempt to cause the human to react and do what was done ten years ago, as the reactive mind knows whatever that was, it led to survival. It makes no sense to the analytical mind of the human involved in view of the present time situation, (eg. no cause of new pain is present), but part of the problem is that, just as ten years ago, the analytical mind becomes attenuated when the reactive mind perceives that a painful situation which was survived before, is happening again. And, if the analytical mind attempts to stay conscious, the pain in the prior experience turns on, (ie. psycho-somatics), to force compliance with reactive memory commands. While the reactive mind has some utility in an animals world, it completely lost that utility in the human world when language was developed. As alluded to, the reactive mind interprets language entered thereinto literally, and the literal meaning of words and phrases is often, if not nearly always, very different than that intended by the presenter thereof in the context in which it is presented. An example was also provided wherein it was supposed that a man gets mugged and knocked out by a hit on the head at a gas station late on a hot and humid night, when the smell of gas permeates, while being told youre going down by the mugger. Years later, when again at a gas station late on a hot and humid night with the smell of gas again present, it can happen that the man will have an urge to literally get down on the ground. And if he opposes that it can occur that his head will start to hurt. And if he continues to oppose the reaction being demanded by the reactive mind, he can actually go unconscious, all as a reactive dramatization of the mugging experience years ago. The subject might try to explain what occurs via a Figure-Figure type of what many people see as Reasoning, but it never makes sense. Further, Wolf (12)-(16) suggests that the cells of our bodies collapse wavefunctions, as do our sense organs, (sight, sound, touch, smell and taste), therefore it is possible that the somatic mind level has content entered thereinto of which a person is not consciously aware, much like experiential memories can be hidden away in ones reactive mind level.

While people reading the foregoing often get a feel that there is something to it, the question is begged—does the human brain, which is generally considered to house the human mind, (although that is open to debate), provide any structure that supports it. The answer was—yes it does.

It was discussed that, while substantially silent as regards location of a life motivation source, medical literature very definitely identifies the pons and medulla oblongata regions of the human brain as associated with somatic level monitoring and control. It further identifies the thalamic levels, (ie. the diencephalon), of the human brain as being very much similar to the highest brain level in animals, and it is generally observed that animals behave based primarily on a stimulus response basis. It is noted that substantially all, if not all, human sensory input information is available to this level. There is also present in humans, however, a very prominent cerebral cortex structure. While some similar structure can be found in animal brains, it is never as substantial as it is in the human brain. Further present in the human brain is something called the Circuit of Papez, lesions in which inhibit memory formation (4). Although additional structure is sometimes attributed to the Circuit of Papez, that terminology is here used to identify projections from the thalamus to a temporal region in the brain called the hippocampus, from which projects a structure called the fornix. The fornix projects to what are called the mammilllary bodies, from which there are projections to the cingulate gyrus, which is a part of the cerebral cortex. That is, there is a known definite circuit pathway between the thalamic and cortical levels, and it is further well known that that the hippocampal regions play a significant role in the formation of conscious human memory and provide keys of access to memory (5). It is also mentioned that the hippocampus is a part of what is called the Limbic system, and that system is highly involved in emotional aspects of human behavior. It is suggested very emotional events can therefore adversely affect hippocampal performance in memory transfer between the thalamic level to the cortical level of the human brain. Further, there is a structure called the reticular activating system in the human brain that plays a large role in governing the availability of human consciousness. The reticular activating system, for instance, plays a part in evoking sleep by attenuating cortical activity (8).

Dianetic processing was disclosed to involve mental processes that identify and transfer content present in a human reactive (subconscious) mind level to a human analytical (conscious) mind level. It is found that when this is done the reactive content power over a human's conduct is diminished. It was contended that the circuit of Papez provides the thalamus-hippocampus—fornix—mammillary body—cingulate gyrus structure in the human brain associated with this memory transfer. And further, it was contended that the reticular activating system is the brain structure associated with attenuating the availability of the analytical level mind during the entry of content into the human reactive mind, unbeknownst to the human analytical mind, and is the brain structure associated with causing the analytical mind to become attenuated when reactive mind content later seizes control of a human via stimulus response.

### Potential Abuse

While the described scenario might conjure up visions of societal mind control, such as was subject in Stanley Kubrick's Clockwork Orange, it is noted that what was attempted therein by government operatives was to implant a subject with a pain tagged subconscious command to become ill upon even contemplating violence. While achieving that goal, it did not work out as those who did it planned. In fact, in the end, what was done worked out very definitely to the subjects benefit. While the author believes that humans are subject to effects of pain tagged subconscious mind content, and mass-media etc. restimulations thereof to effect social control, there is another aspect of humans which generally seeks to avoid suppression.

### The Human Spirit

Welch, in Mind (11), observed that it was interesting to consider to what, in the human example, an exterior operator using an electronic transmitter in the robotics system example, would analogically compare. Scientology teaches that man is comprised of a Static, (termed a Thetan), which has no mass, energy, wavelength, or position in space or time or any other attributes which are identified with presence in the physical universe. The Thetan can be thought of as an individual spirit entity. The Thetan is another component of a human, in addition to the somatic, reactive and analytical mind levels, and the associated body controlled thereby. It is proposed herein that this is absolutely valid, and that the Thetan can, ideally, directly communicate with the analytical mind of the body with which it is closely associated. It is further proposed that the Thetan plays a game of postulating new realities, and attempting to make others agree therewith by interacting on the game field, (ie. the physical universe).

Continuing, what the author herein believes might be new, even in view of the teaching of Scientology, is that there is a possibility that a Thetan can make use of the reactive mind, via the analytical mind, as a consistency seeking co-processor. Where the environment is sufficiently safe so as to not require the reactive mind to operate as described above to achieve basic survival, a Thetan can, via educational processes program the reactive mind to seek consistency in what the analytical mind considers. This might be most observable where a human has been educated in very consistent topics such as math, physics and engineering. The author has no data to prove such a proposal, but discloses that he has often experienced awaking with an answer to a problem with which he was wrestling the night before. It has seemed to the author that while his analytical mind had been confused, the source of the confusion had somehow been overcome and a more simple logical thread had been entered thereinto by a shuffling of data. At times this involves elimination of consideration of data that was causing the analytical mind confusion. In short, it seemed to the author that his education in math and science etc. affected his subconscious as well as his analytical mind in a good way. This might seem real if compared with a subject whos subconscious mind has been conditioned by life in a very tooth and claw environment. While such a subject might know analytically that it makes no sense to act in a, perhaps violent manner in a situation, the effect of a subconscious mind programmed to do so will make it nearly impossible for him or her to not follow the reactive dictates.

### Quantum Reality

Provided in the foregoing is a framework, describing structure and function associated therewith that is useful in describing human behavior. The foregoing is arguably not easily demonstrated other than by improvement in people who become aware of it and apply it. The same is even more true for what follows. In that light it is interesting to consider that Quantum Mechanics teaches that it is possible to measure one of a pair of complementary variables, (eg. position and momentum), to a high degree of precision, but by necessity this precludes measuring the precise value of the other. Rather, a number of value possibilities therefore exist and each has associated therewith a probability. This can be appreciated even on a macroscopic level by considering that if one measures the precise location of a particle at a specific time, then its momentum is completely unknown. Its location is established but it could be have been standing still, or moving at near the speed of light or at any speed in between to arrive at that point. To determine velocity at least some time must pass, and at a precise point of measurement this is not the case. This can be interpreted to show that some limited degree of free will exists to choose what to measure, but the results of exercising it are never 100% certain, and in that is the human condition.

Continuing, Hubbard identifies Emotion with Energy. Quantum Mechanics further teaches that there is an Uncertainty relationship associated with Energy and Time, just as there is with Position and Momentum. (Note, any two parameters that, when multiplied together provide units of Action (eg. (m×2/t)) meet this criteria). That is, if one knows the Energy (Momentum) of something exactly, then the Uncertainty in ones knowledge of an associated Time (Position) of measurement is infinite, and vice-versa. By analogy complimentary relationships exist between intuition and sensation, and between emotion and the thought level of consideration. In addition to the principle of Quantum Uncertainty, Quantum Mechanics teaches that there is a relationship between Energy and (C/Wavelength) via the de-Broglie equation (E=h(frequency)), where h is Planks Constant. For insight, Planks Constant also relates Wavelength and Momentum via (P=h/wavelength).

### Scientology Insight

Scientology provides many insightful scales. Three scales relevant herein are:

| | | | KNOW TO |
|---|---|---|---|
| EMOTIONAL TONE (A) | | REALITY (R) | MYSTERY (C) |
| 40.0 | SERENITY OF | POSTULATE | KNOW |
| | BEING | | |
| 8.0 | EXHILARATION | SUPPOSITION | NOT-KNOW |
| 4.0 | ENTHUSIASM | CONSIDERATION | REMEMBER |
| 3.0 | CONSERVATION | AGREEMENT | FORGET |
| 2.5 | BOREDOM | TERMINAL | KNOW ABOUT |
| 2.0 | ANTAGNOISM | LINE | LOOK |
| 1.8 | OVERT HOSTILITY/ | PARTICLE | EMOTION |
| | PAIN | | |
| 1.5 | ANGER | BLACKNESS/ | EFFORT |
| 1.1 | COVERT | INVISIBILITY | FIGURE- |
| | HOSTILITY | | FIGURE |
| 1.0 | FEAR | | THINKING |
| 0.5 | GRIEF | | SYMBOLIZING |
| 0.05 | APATHY | | EATING |
| 0.0 | DEATH/FAILURE | | SEXING |
| −0.02 | REGRET | | NOT-KNOW |
| 1.0 | BLAME | | MYSTERY |
| −1.3 | SHAME | | |
| −1.5 | CONTROL | | |
| −1.3 | RESPONSIBILITY | | |
| −2.2 | PROTECT | | |
| −3.0 | OWNERSHIP | | |
| −3.5 | NEEDING | | |
| | APPROVAL | | |
| −4.0 | NEEDING BODIES | | |
| −8.0 | HIDING | | |
| <−8.0 | WAITING | | |

(The author considers the + and − Emotional Tone Scale entries as for mind + body, and − for mind-sets respectively).
(NOTE—the foregoing are adapted from, not exactly copied from Scientology 0-8 (17), and the following is the authors interpretation thereof).

As alluded to, Hubbard described Emotional Tone as being energy manifestations, with each level having associated therewith a wavelength. In fact, he identified three basic energy manifestations as Flow, Dispersal and Ridge and identifies harmonic, (that is why numbers are associated with the Emotional levels), relationships between various levels. For instance Anger and Conservation are ridges, while Overt Hostility is a Flow and Fear is a Dispersal.

In addition, the Reality Scale Thought related Consideration level is indicated as having some objective time element associated therewith, whereas Postulate and Supposition are timeless static. Of course, levels below Consideration (eg. Agreement), are also tagged with time, but at an Emotional Tone of Serenity, and with Reality at the Postulate level, in the context of Total Knowingness, it is possible to conceive of a static having no position in time or space or having any wavelength. This could be the state of a being that is outside of objective mass, energy, space and time. (Hubbard taught that consideration takes rank over mechanics, which implies Postulate trumps all). And, as regards the Know to Mystery Scale, it should be noted that going from Know-About to Look, enters Space and one must then Look to Know. Further, when Space is present, Communication must occur to transfer information, and that involves idea movement that involves Intuition/Sensation, which it is noted, are Complimentary entries from the same Scale. Thus, one can monitor a level thereon as an Intuition (female?) or a Sensation (male?), with accompanying uncertainty, while Emotion and Reality are on different scales with uncertainty applying therebetween.

### Additional Insight

Wolf, in The Body Quantum (13) analogically identifies Thought with Time, and Feeling with Energy, with Energy and Feeling resulting in Emotion. This was very insightful to the author herein upon reading it, but it seemed that analogizing Thought generally with Time needed clarification, while Energy is directly analogous to Emotion. It is suggested that a better analogy provides that Thought is analogically associated with a Consideration level of Thought, wherein thought, the author suggests, can be viewed as consisting of the timeless Postulate, Supposition levels, and the time influenced Consideration and below levels of the Reality Scale. For insight, it is also noted at this point that the Agreement level of the Reality Scale is an entry to the mechanics level of Reality which are characterized by the Communication related attributes of the Terminal, Line and Particle, and the Blackness and Invisibility levels represent Unreality. Agreement, however, generally passes for the only criteria of reality in every day human life, a fact that politicians know very well indeed.

Further, Wolf (12) relies on concepts in Quantum Mechanics enhanced by tachyons, (mathematically imaginary particles that move at a velocity faster than that of light), to postulate that a universal ONE mind exists, (which might be associated with the Higgs field), that plays a role in causing wave function collapse to what is observed as the real world. The mind of God might be continually causing the world, as we know it, to persist by making infinitely many decisions as to what each wave function-particle in it does. This might suggest a basis for what religions teach is the result practicing intention or postulate oriented processes, like meditation or prayer. Perhaps the human spirit can access, lobby and influence the mind of God to make decisions favorable thereto, via wave-function collapse consistent with its viewpoint. It might even be possible to step back out of existence, (eg. death), and view it in a single glance, the doing of which might just cause it to vanish, for that being.

It is further suggested that one at Serenity, Postulate and Knowingness, begins a decent into physical reality by a Postulate to Not-Know, and begin Observing. This leads to Looking, and associated Quantum Wavefunction collapse, which takes one from Postulate and Supposition Reality through Consideration to Agreement with objective reality. And, in view of the Uncertainty relationship between energy and time, this means that Emotional Tone and Agreement are not simultaneously determined. That is, the more certain one is of his or her emotional level, the less certain he or she will be about what he or she agrees is real. And the more certain one is of his or her agreement reality, the less certain he or she will be about his or her emotional state. This does not mean one will not have an agreement reality and emotional state, only that both are not simultaneously determinable by the individual, who is absolutely certain of his of her emotional state or agreement reality, respectively. At this point, for effect, it is noted that it is well known in Quantum Mechanics that what one measures determines what one will have confidence in knowing. The most common example is that if one sets up to measure momentum, (perhaps only average momentum is actually measurable), that can be determined with high confidence, and if one sets up to measure the complimentary position, one will have high confidence in knowing that. In the first case, knowledge of position will have a large uncertainty associated therewith, and in the second case, momentum will have a large uncertainty associated therewith.

Applying the analogies of Energy/Emotion, Time/Consideration, Momentum/Intuition and Position/Sensation, it can be gleaned that a person can be tuned in to, with certainty, monitoring a Thought Reality and a Know-Mystery Intuition, along with an uncertain Emotional Tone, via an elected operators. Hence, two people monitoring the same input can come away with very different certain knowledge based on what he or she was tuned-in to monitoring. How one observes determines what becomes real therefore, much like how applying a position or momentum mathematical operator to a wavefunction provides a position or momentum Eigenvalue, respectively. (Consider—are witnesses ever reliable?).

### Application

To demonstrate the concepts disclosed herein, suppose we have a spirit in the state characterized by Serenity, Postulate Reality and Knowingness. It is suggested that such a spirit would be outside of the physical universe and not be at all affected by objective mass, energy, space and time or any Quantum wavefunctions that propagate therewithin to provide probabilities of manifestations. This is a postulated state of pure massless, spaceless and timeless spirit. It is noted that Wolf (16) describes spirit as vibrations of nothing, soul as spirit reflecting from nodes of time and matter as reflecting from nodes of space. Self is described as spirit reflecting from mass. It is suggested that the Scientology Thetan is not Wolfs spirit/soul, as the later is dependent on preexisting created space and time, rather than being of a nature that creates mass, energy, space and time and is not therewithin. Wolfs spirit/soul might be more consistent with what Scientology terms a Genetic Entity, which is responsible for developing and maintaining the physiology of bodies, such as those on earth. Continuing, Hubbard taught that happiness derives from the known overcoming of not-unknown obstacles toward a known goal, and a spirit/Thetan, not comprising mass, energy, space and time obstacles, is not happy. Even though it is demonstratably not good for them, Thetans undertake to Not-Know and descend into the physical universe via a dwindling spiral, perhaps for the purpose of, as Hubbard suggests, to cause an effect and to play a game therein. Descending to Look on the Know to Mystery Scale observably enters Space, as one must then look through Space to Know in that state, instead of Just Know above that level. The distinction between Just Know and Look to Know can be grasped by considering one just knows the solution to a math problem after working it out, but prior thereto must look and apply reason to arrive at the answer. It is also noted that Space/Beingness-Awareness provides the separation via necessary to make communication necessary in order to Know (whats there). Hence the presence of Space ushers in the necessity of Communication (to Know).

Continuing, Hubbard teaches that Understanding is a Universal Solvent, resulting from beneficial Affinity, Reality and Communication, (ie. ARC-Triangle) interaction. If one changes one of A, R and C, the others, it is taught, also change so that all increase/decrease alike on the various scales. It is suggested one can identify A with the Emotional Tone Scale, R with the Reality Scale and C with the Know to Mystery Scale (as it provides Space through which Communication occurs, eg. without a space to communicate through, there would be no unknown information to communicate to another location, hence communication would have no meaning). Note the Reality Scale includes mechanics of communication levels, where the Know to Mystery Scale Space necessitates communication to transfer information therethrough. Further, descending to Consideration on the Reality Scale enters objective Time and descending to Exhilaration on the Emotional Tone Scale enters objective Energy. Along with the objective Space entered by descending from Knowing to Looking, all the necessary components for an objective physical universe are achieved. Descending below Look on the Know to Mystery Scale lands one in Emotion, which opens the gamnut of Emotions on the Emotional Tone Scale to the being. Further, it is typical that one descending into Emotion will also descend into the Communication levels of Terminal, Line and Particle on the Reality Scale, and this will focus the being on using force to communicate over objective universe lines via movement of particles, thereby further leading to decent into Effort o the Know to Mystery Scale as Effort is a directed force. It is also suggested that Effort/Dynamic-Intent can be analogically considered to be directed classical Force/Reason leading to Work/Answer that can appear at any Energy/Emotional Tone, when a mass/idea is moved through a Space/Being-Awareness, if the complimentary Time/Consideration is determined precisely. Note, Answer is analogically identified with Work, which has units of Energy. It is proposed, however, that Answers are not at a fixed location on the Emotional Tone Scale, but rather float over the entire spectrum. That is, one can be absolutely Consciously Certain of a Consideration, but only if accompanied by an uncertain, (unconscious reactive mind content?), Emotional tone level. Understanding then, can approximate, for instance, Looking at Consideration about an Answer, in a Being-Awareness—Thought Reality Continuum. A very low level Understanding approximates Mystery about Black-Invisible Death, and a very high level Understanding approximates Remembering Postulated Serenity. The reader can formulate many such examples, but must keep in mind that while one can observe an Intuition from the Know-Mystery Scale, the Uncertainty Principle prevents precise determination of both an entry from the Reality Scale and from the complimentary Emotional Tone Scale, simultaneously, (below the static Serenity, Postulate and Know level).

An important point is that when one is submerged in the physical universe, because of quantum uncertainty which, even though making freedom possible to make choices, provides no way to know that the effect of those choices will be. One faces a No (Know?) Direction Home DYLAN, scenario. So positioned, beings often try to navigate a way out, but find that Consideration and Emotional Tone are related by the Uncertainty Principle thereby frustrating an experiential simultaneous grasping of an objective Energy, Time and Space State, (ie. objective Understanding). If one observes a certain thought Consideration, Emotional feel will be absolutely Uncertain, and Emotional Certainty about something makes Consideration thereof very Uncertain. It is suggested that adopting an approach of trying to understand a Consideration while Emoting therefore presents a very difficult task, especially in view of a persisting influence of the human reactive mind, which can cause attenuation of the analytical mind and install reactive mind control of a human based on prior experience effected stimulus response, as discussed earlier in this paper, and in reference (11). However, other approaches, such as physically exerting Effort to Agree about Hostility are even more problematic, thus serve only to eventually land one in trying dead-end Intuition/Sensation Figure-Figure Thinking activity.

While the foregoing situation is presented as generally the case, it is additionally presented that when one Reasons through a math problem and gets the right answer, it predictably results in an Emotional tone of Enthusiasm or Exhilaration, or at least Conservatism, while getting a wrong answer can predictably result in an Emotional Tone of Apathy or Anger or at least not better than Boredom. That is, there is a weighing probability factor that applies when a solid criteria for determining what is objectively correct exists. In such areas it is suggested that one will have a feel that being very certain about a Consideration of, for instance, a math problem does not require a complete Uncertainty about their accompanying Emotional Tone. However, if people reason like the Monty Pythoners humorously did when proving a gal was a witch, or view reason as reactively responding to subconscious pain tagged memories, this probability weighting does not apply. Further, those of us, who have done Scientific Research or Patent procurement, (see (18)-(27)), are very much aware of the AH-HA feeling that results when success is achieved. It is suggested that this AH-HA feeling results from predictably arriving at the Emotional Tone of Exhilaration, via Reasoning. Typically such a result starts at an Intuition level of Know-About on the Know to Mystery Scale, then descends to Look and Effort during the doing of Reasoning Work, which occurs at a Reality level of Consideration consistent with Agreement when the breakthrough happens. The Author has personally experienced this AH-HA feeling, as well as many short term decents into Apathy and Anger or the like when results from Reasoning and Work were not yet successful, as had been the Postulated Intended hope. This is mentioned, as the author believes that success in intended manipulation of objective mass, energy, space and time can, in a sense, sidestep the Uncertainty principle and allow one to reach Knowing Supposed Exhilaration simultaneously, on the Know to Mystery, Reality and Emotional Tone scales, respectively, with a very high Certainty being associated with all components. That is, the closer to Serenity Emotional Tone, Postulate Reality and Intuition Know on the Know to Mystery Scale one operates, the less applicable is the Uncertainty principle, as the less influenced one is by objective energy, time and space, the less applicable the Uncertainty principle becomes. At Serenity, Postulate and Know Uncertainty disappears, as all is absolutely Certain in the absence of Observing objective Energy, Time and Space.

It is also mentioned that conventional religions and therapies often seek to shift how an individual knowingly and responsibly seeks to collapse Quantum wavefunctions, so that he or she observes Considerations/Intuitions with Certainty, as opposed to observing Emotions/Sensations. This change in approach can aide with assuming a viewpoint from beyond existence, at Serenity, Postulate and Knowing, thereby enabling the practice of intention postulate thought processes aimed at becoming free from the traps and trials and tribulations inherent in being in the objective physical universe. But, perhaps, the only requirement to being out is to Just Know there is an out and that it results from a simultaneous consideration of what is both in, and out, and striving to raise each of A, R and C independently, to sidestep uncertainty and arrive at ever more Certain levels of Understanding.

### Sidestepping Uncertainty

A way to sidestep uncertainty, in a practical sense, exists because emitters of wave-functions typically do not emit one wave-function and be done with it. They instead emit a sequence of essentially similar wave-functions that represent the State of the emitter thereof, and while one of said sequence of wave-functions can not be observed to provide values for both of a complimentary pair of variables, one can observe one wave-function to, for instance, provide a value for Momentum and observe another to determine Position and another to provide a value for Energy. Mathematically this corresponds to applying a Momentum Operator to the State Vector of one wave-function and a Position Operator to the State Vector of another and an Energy Operator to the State Vector of yet another. This does not defeat uncertainty, but does render it far less a barrier. While it is true that one observation cannot simultaneous evaluation of say Momentum and Position from observing a single wave-function, there is a simple way to avoid the problem. Analogically this means one can view his or her situation as a Beingness State that emits a sequence of essentially similar wave-functions, and can sequentially focus on determining Emotion form one thereof, Intuition from another thereof and Sensation from another thereof. Answering questions like:
How do you Emotionally feel about XXX,
What do you Intuit about XXX, and
What Sensation do you perceive about XXX
   can progressively, when answered over and over lead to very insightful answers.

The reader might have noticed that no questions about Time/Reality were included in the above list. This is intentional and is because in Quantum Mechanics there is no Time Operator, similar to Energy, Momentum and Position Operators, such that its application thereof to a wave-function State Vector returns a value for Time. Thus, while one can ask questions about Reality, it must be understood that answers thereto represent Illusions. The Energy compliment of Time is not observably real. However, people do generally agree that Time is a component of the physical universe, and they are correct. Its just that Time is different. With that caution, one can beneficially add questions about Reality to the above listing, such as:
What is your Consideration of XXX, or
What is your Agreement out XXX
   with benefit. It must be appreciated though that Reality is an Illusion and that answers to said additional questions are not as solid as are questions about Emotion, Intuition and Sensation.

### Welch Certainty

It would be better if Uncertainty could be avoided, rather than sidestepped. In that light it is disclosed that Welch, (18) (19) (20), has argued that the Heisenberg Uncertainty Principle is not an absolute. Based upon a look at the geometry of the Interference Pattern developed by a Double Slit System, Welch proposed an experiment that could show that it is possible to know, with a better certainty than allowed by Heisenbergs Principle, which slit of a double slit system it is more probable that a particle passed in the process of forming the Interference Pattern. The approach is based on determining information about positions of particles that contribute to the pattern one at a time. In a letter published coincident with this paper, Welch also argues that if one considers a bistable Energy system, such as an atom with at least two definite energy orbitals, one can apply energy to cause an electron therein to enter a high energy state, then turn off the energy and subsequently observe a photon emission—at the Time when the electron returns to the low energy state. Welch contends that it can therefore be experimentally shown that at the time the photon is observed, the complimentary energy state is also known with certainty. It is suggested herein that this implies that Intuition and Sensation, and Emotion and Consideration can be simultaneously determined with reduced or no uncertainty where, for instance, Consideration, (associated with an objective Time), merges into timeless Postulate, and as Emotion, (associated with an objective Energy), merges into infinite Serenity, and Looking, (associated with an objective particle position in Space), merges with Spaceless Knowingness. This is because Quantum probability wave-functions manifest in objective Space and Time, while Postulate Reality, Serenity and Knowingness are beyond Time, Matter and Space, whereat Certainty controls. And, there seems to be a relationship between Emotion, Reality and Intuition such that predictable Understanding results from all increasing/decreasing simultaneously, toward infinity, or toward an uncertainty of (h/2) inside of objective existence, and to 0.0 outside thereof, respectively. It is known that both Energy (Emotion) and Momentum (Intuition) increase with frequency, and if Consideration is inversely related to Time, (ie. it merges into Timeless Supposition at shorter durations), the end result could be an entangled, (at least correlated), manifestation called Understanding.

### Where are You

It is probably safe to say that most people find the idea of Being at near Emotional Serenity, Postulate Reality and Knowingness very—Unreal—, with blackness and invisibility appearing when they try to grasp such. In addition, if people examine their lives, most will be very aware that what has happened to them, especially if painful, has a very close-in lingering reactive influence on them. Further, most people will find more familiarity with Emotional tone levels below Conservation than those thereabove, with their Reality being characterized by Agreement with social influence imposed upon them via use of the Communication levels of Terminal, Line and particle, (eg. they have and constantly use cell phones and access other media to get insight to reality, via messages, (ie. particles received over lines)), and they are focused on knowingness levels nearer to Mystery, (eg. in particular eating and sexing), than to Looking and Knowing. People have to accept that they are personally responsible for their own reality and enjoy, or if not happy, change at what they Look at and Consider, for otherwise they will remain fixed reactive memory controlled stimulus response emotional level affects below Boredom on the Tone Scale.

In summary, it is argued that the human brain contains structure consistent with the teachings of Dianetics, and with demonstratable capabilities of robotic systems applied to investigation of, analysis of, and to some extent, control of an environment in which it finds itself Further, Scientology teaches that humans comprise a Thetan (spirit), which is separate from other Thetans and from its associated human mind and body, but interacts therewith primarily via the analytical mind. It is further suggested that when the reactive mind can be programmed and used by the analytical mind as a consistency seeking co-processor in the solving of problems which are confusing to the analytical mind level. It is also suggested that practice of intention related mind processes, (meditation or prayer etc.), to affect matter might find basis in quantum mechanics in view of the effects of faster than light mathematically imaginary tachyons which others, (Wolf), have suggested might comprise the mind of God. Quantum concepts are presented that give insight to how the human mind might provide that emotion and consideration, as well as Intuition and sensation, might be complimentary pairs, thereby making the uncertainty principal applicable. It is also noted that uncertainty might not be an absolute, and is suggested that assuming a viewpoint beyond objective existence, in combination with intentioned postulate thought processes might free one from the effects thereof.

### BRIEF DESCRIPTION OF THE DRAWINGS

FIG. 1 shows a system for carrying out the present invention method.

### DETAILED DESCRIPTION

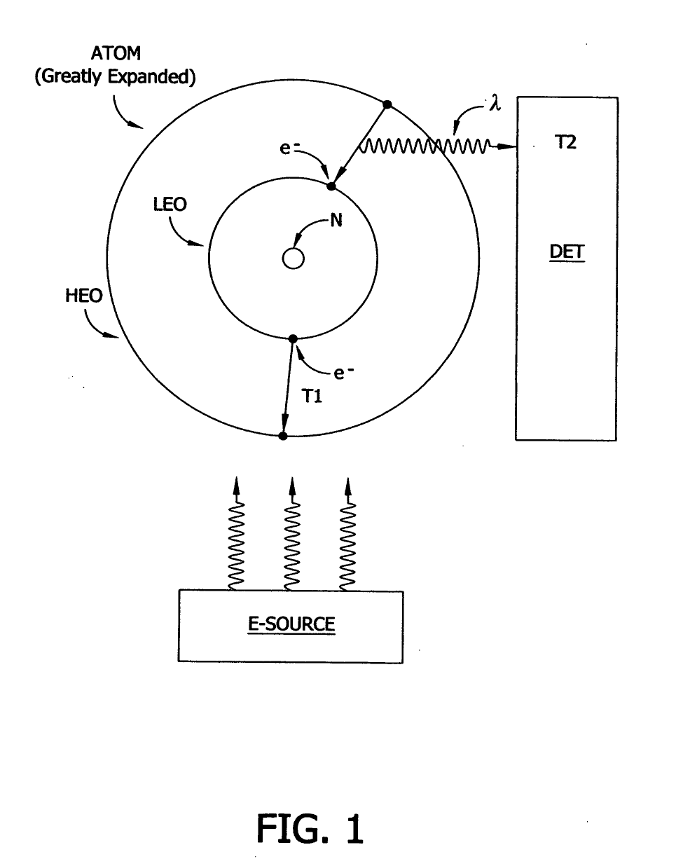

FIG. 1 shows a system for carrying out the present invention method. Shown is a greatly expanded Atom (ATOM) comprising an Electron (e⁻), a Nucleus (N) and two Energy States, (eg. High (HEO) and Low (LEO) Orbitals). Also shown is an Energy Source (E-SOURCE) and a Detector (DET). In use the Energy Source (E-SOURCE) is applied at time T1 to cause the Electron (e⁻) to advance from the Low (LEO) Orbital Energy State, to the High (HEO) Orbital Energy State. At time T2 the Electron (e⁻) energy descends from the High (HEO) Orbital Energy State to the Low (LEO) Orbital Energy State, and in so doing emits a Photon ( ) which enters the Detector (DET) where it is detected/observed.

It is argued that, where the Detector (DET) is positioned substantially coincident with the Atom (ATOM), at the exactly known Time T2, the Electron Energy (e⁻) is simultaneously known as that allowed by the Atom's Low (LEO) Orbital Energy State, thereby overcoming the Uncertainty Principle.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the Claims.

### REFERENCES AND BIBLIOGRAPHY

1. Dianetics, The Modern Science of Mental Health, Hubbard, Scientology Publications World Wide, (May 1950).
2. The Neuro-Anatomy of Learning and Memory, Welch, Advanced Neuro-Anatomy Semester I, University of Nebraska Medical Center, (1976).
3. Behavior Alteration as a Result of Memory and Stimulus, Welch, Advanced Neuro-Anatomy Semester 2, University of Nebraska Medical Center, (1976).
4. Man and his Temporal Lobes, Walker et al., Surgical Neurology, Vol. 1, No. 2, pp. 69-79, (1973).
5. Memory, Penfield et al., Archives of Neurology, Vol. 11, pp. 145-154, (1974).
6. Psychosurgery and the Limbic System, Postgraduate Medical Journal, Kelly, Vol. 49, pp. 825-833, (December 1973).
7. Memory Loss Due to Hippocampal Lesions, DeJong et al., Archives of Neurology, pp. 339-348, Vol. 20, (April 1969).
8. A Textbook of Physiological Psychology, Grossman, John Wiley and Sons Inc., New York, pp. 627, (1967).
9. The Human Nervous System, Barr, Harper and Row, (1974).
10. Extreme Autobiographical Memory, 60 Minutes, CBS, December 2010.
11. Mind, Welch, ISAST Transactions on Computers and Intelligent Systems, Vol. 3, No. 1, (2011).
12. Time Loops and Space Twists, Wolf, Hierophant Publishing, 2010.
13. The Body Quantum, Wolf, MacMillian Publishing, (1986).
14. Taking the Quantum Leap, Wolf, Harper and Row, (1981).
15. Star Wave: Mind Consciousness, and Quantum Physics, Wolf, MacMillian, (1989).
16. The Spiritual Universe-How Quantum Physics Proves the Existence of the Soul, Wolf, Simon & Schuster, 1996.
17. Scientology 0-8, Hubbard, Scientology Publications Organization, 1970.
18. The Uncertainty of Uncertainty, ISAST Transactions on Computers and Intelligent Systems, No. 2, Vol. 2, 2010 (ISSN 1798-2448).
19. The Welch Certainty Principle; ISAST Transactions on Computers and Intelligent Systems, No. 1, Vol. 3, 2011 (ISSN 1798-2448).
20. The Welch Certainty Principle Continued; ISAST Transactions on Computers and Intelligent Systems, No., Vol., 2011 (ISSN-). TBP August 2011
21. Macroscopic Evidence of Uncertainty, Welch TBP August 2011
22. Mid-Bandgap Doped Junction Single Semiconductor Type Device Alternative to Conventional Dual Device CMOS, Welch, ISAST Transactions on Electronics and Signal Processing, No. 1, Vol. 4, 2010 (ISN 1707-2339).
23. Insight to Operation of A Mid-Bandgap Doped Junction Single Semiconductor Type Device Alternative to Conventional Dual Device CMOS, Welch, ISAST Transactions on Computers and Intelligent Systems, No. 1, Vol. 3, 2011 (ISN 1798-2448).
24. Fabrication of Sub-Micron Channel DMOST-Type MOSFETS by Ion Implantation of Source, Drain and Channel, Welch, TBP August 2011
25. Design and Fabrication of Sub-Micron Channel MOS. Transistors By Double Ion Implantation, Welch, MASC. Thesis,
University of Toronto (1974), (Graduate Advisor Prof. R. S. C. Cobbold).
26. Method of Providing Audio Format Information Update Service Over the Internet, Welch TBP Aug. 27, 2011. United States Patent Office (USPTO) Website listing of over 250 patents produced by Attorney Welch., over half being at the Ph.D. level.
27. Mind—Beyond Matter, Welch, ISAST Transactions on Computers and Intelligent Systems, No., Vol., 2011 (ISSN). TBP
28. “Particle Physics for Non-Physicists: A Tour of the Microcosmos”; Pollock, The Teaching Co. (2003).
29. “The Feynman Lectures on Physics”, Chapter 37, Feynman et al., Copyright California Institute of Technology (1965)), Addison-Wesley Publishing, (1965).
30. “Entangled”, Aczell, Raincoast Books, (2002).
31. “Quantum Mechanics” by Albert Messiah is identified as it mentions the topic of conducting the Double Slit experiment in a Cloud Chamber and dismisses it based on momentum uncertainty in the ionization processes. However, no experimental evidence is provided to prove the statement.
32. “Unsharp Particle-Wave Duality in a Photon Split Experiment”, Mittelstaedt et al. Foundations of Physics, Vol. 17, No. 9, 1987.
33. “Lectures On Physics”, Chapter 37., Feynman et al., Addison Wesley, 1963, Optics, Chapter 10, Hecht, Addison-Wesley, 1987.1987.
34. Unsharp Particle-Wave Duality in a Photon Split-Beam Experiment, Mittelstaedt et al., Foundations of Physics, Vol. 17, No. 9, 1987.
35. Warped Passages; Lisa Randall, Harper Collins, 2005, ppg. 133-35.
36. The Grand Design; Stephen Hawking, Bantum Books, 2010, ppg. 63-66, 68, 70, 83, 135-36.
37. The Hidden Reality; Brian Greene, Alfred A. Knopf, 2010, ppg. 193-95, 205.
38. Wave-Particle Duality with Electrons, Batelaan, Perimeter Institute for Theoretical Physics, 2011.
39. “Migration of Ion Implanted Krypton in Silicon during Anneal”, Welch, Cobold, Davies, J. App. Physics, Vol. 48, No. 11, November 1977.

I claim:

1. A method of showing the uncertainty principle is not absolute comprising the steps of:
A) providing a system comprising:
a) an isolated, shielded effectively bistable energy atomic system with at least two, (high and low), stable known energy state orbitals;
b) an energy source capable of creating a field of an appropriate strength to excite an electron in said atomic system from the low energy state to the high energy state;
c) a detector of electromagnetic radiation is substantially coincident therewith;
said method further comprising:
B) at a time (T1) applying said energy source to cause an electron to be forced into the high energy orbit in an atom, and then turning it off;
C) said detector, at time T2, observing a photon has entered thereinto which was emitted by the atomic system, when the electron descended from the excited high energy state back into the low energy state, thereby providing release of energy to form the photon; and
recognizing that at instant (T2), when the detector observes detection of a photon, an exact measurement of a Time occurred, in combination with knowledge that said electron is present in the known low energy state, said simultaneous knowledge being a violation of the uncertainty principle which precludes simultaneously knowing the energy other than with infinite uncertainty, when time is measured exactly.
